(19) United States
(12) Patent Application Publication
(10) Pub. No.: US 2026/0296426 A1
(43) Pub. Date: Oct. 1, 2026

(54) VEHICLE CONTROL APPARATUS AND PROGRAM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Masahide KUWATA, Tokyo (JP); Yuji KOSAKA, Tokyo (JP); Takahiro NAKANO, Tokyo (JP)

(21) Appl. No.: 19/576,587

(22) Filed: Mar. 24, 2026

(30) Foreign Application Priority Data
Mar. 28, 2025 (JP) 2025-054898

(51) Int. Cl. B60W 30/16; B60W 40/107; G06V 10/98; G06V 20/58

(52) U.S. Cl. CPC B60W 30/162; B60W 40/107; B60W 2420/403; B60W 2520/105; B60W 2552/10; B60W 2554/4041; B60W 2554/4045; B60W 2554/802; B60W 2554/804; B60W 2720/106; B60W 2754/50; G06V 10/98; G06V 20/58; G06V 2201/08

(57) ABSTRACT

A vehicle control apparatus controls a travel speed of an own vehicle. The vehicle control apparatus determines whether another vehicle is traveling in an adjacent lane adjacent to an own vehicle lane in which the own vehicle travels and the other vehicle has turned on a turn signal on a side of the own vehicle lane. The vehicle control apparatus determines whether another vehicle speed that is a travel speed of the other vehicle is lower than an own vehicle speed that is the travel speed of the own vehicle. In response to the turn signal in the other vehicle being determined to be turned on and the other vehicle speed being determined to be lower than the own vehicle speed, the vehicle control apparatus performs deceleration control of the own vehicle with a speed obtained by adding a predetermined offset speed to the other vehicle speed as a target speed.

### CROSS-REFERENCE TO RELATED APPLICATIONS

This application is based on and claims the benefit of priority from Japanese Patent Application No. 2025-054898, filed on Mar. 28, 2025. The entire disclosure of the above application is incorporated herein by reference.

### BACKGROUND

The present disclosure relates to a vehicle control apparatus and a program.

A technology in which, in a case in which another vehicle is traveling in the vicinity of an own vehicle and the other vehicle turns on its turn signal (direction indicator), travel speed of the own vehicle is controlled based on movement of the other vehicle is known.

### SUMMARY

One aspect of the present disclosure provides a vehicle control apparatus capable of controlling a travel speed of an own vehicle. The vehicle control apparatus determines whether another vehicle is traveling in an adjacent lane adjacent to an own vehicle lane in which the own vehicle travels and the other vehicle has turned on a turn signal on a side of the own vehicle lane. The vehicle control apparatus determines whether another vehicle speed that is a travel speed of the other vehicle is lower than an own vehicle speed that is the travel speed of the own vehicle. In response to the turn signal in the other vehicle being determined to be turned on and the other vehicle speed being determined to be lower than the own vehicle speed, the vehicle control apparatus performs deceleration control of the own vehicle with a speed obtained by adding a predetermined offset speed to the other vehicle speed as a target speed.

### BRIEF DESCRIPTION OF THE DRAWINGS

In the accompanying drawings:

FIG. 1 is a configuration diagram illustrating an overview of a vehicle control system;

FIG. 2 is a diagram for explaining a scene in which another vehicle cuts in;

FIG. 3 is a time chart illustrating an overview of deceleration control of an own vehicle after a turn signal of another vehicle is turned on;

FIG. 4 is a diagram illustrating a relationship between a longitudinal distance D1 and an offset speed β;

FIG. 5 is a diagram illustrating a relationship between an own vehicle speed VN and a target acceleration Atg2;

FIG. 6 is a diagram illustrating a situation in which cutoff of another vehicle occurs;

FIG. 7 is a flowchart illustrating processing steps for vehicle speed control; and

FIG. 8 is a diagram illustrating a relationship between the own vehicle speed VN and the target acceleration Atg2.

### DESCRIPTION OF THE EMBODIMENTS

In a technology described in JP 2021-024422 A, when another vehicle traveling ahead of the own vehicle turns on its turn signal, control is performed based on a behavior pattern of the other vehicle. Specifically, after the other vehicle turns on its turn signal, whether the other vehicle is in a state of cutting into a line of vehicles (first state), a state of changing traffic lanes to the line of vehicles (second state), or a state of pulling closer toward the line of vehicles (third state) is determined based on an angle formed by a travelling direction of the other vehicle and a longitudinal direction of the road. The own vehicle is controlled based on the determination result.

Incidentally, as a typical traveling scene, a scene in which the own vehicle is traveling in an own vehicle lane, another vehicle is traveling in an adjacent lane adjacent to the own vehicle lane, and the other vehicle in the adjacent lane cuts in front of the own vehicle after turning on its turn signal can be assumed. In this case, deceleration control in which the own vehicle is decelerated based on the movement of the other vehicle is performed in the own vehicle. However, the other vehicle does not necessarily cut in front of the own vehicle even should the other vehicle be in a state in which its turn signal is turned on. In actuality, the own vehicle may be unnecessarily decelerated regardless of the other vehicle not cutting in front of the own vehicle.

For example, in cases in which the other vehicle cuts in behind the own vehicle after turning on the turn signal or the other vehicle erroneously turns on the turn signal, the deceleration of the own vehicle is unnecessary and excessive deceleration is performed. Should the excessive deceleration be performed in the own vehicle after the turn signal is turned on, the own vehicle may become excessively close to a following vehicle and cause traffic congestion. In addition, when the own vehicle attempts to overtake the other vehicle upon realizing that the other vehicle will not cut in, a driver may experience discomfort due to re-acceleration of the own vehicle being delayed.

It is thus desired to provide a vehicle control apparatus that is capable of appropriately performing deceleration control of an own vehicle when another vehicle in an adjacent lane suggests cutting in toward an own-vehicle-lane side.

One exemplary embodiment of the present disclosure provides a vehicle control apparatus capable of controlling a travel speed of an own vehicle, the vehicle control apparatus including: at least one of (i) a circuit and (ii) a processor with a memory storing computer program code executable by the processor, the at least one of the circuit and the processor configured to implement: a turn signal determination unit whether determines whether another vehicle is traveling in an adjacent lane adjacent to an own vehicle lane in which the own vehicle travels and the other vehicle has turned on a turn signal on a side of the own vehicle lane; a speed determination unit whether determines whether another vehicle speed that is a travel speed of the other vehicle is lower than an own vehicle speed that is the travel speed of the own vehicle; and a deceleration control unit that performs deceleration control of the own vehicle with a speed obtained by adding a predetermined offset speed to the other vehicle speed as a target speed, in response to the turn signal determination unit determining that the turn signal in the other vehicle is turned on and the speed determination unit determining that the other vehicle speed is lower than the own vehicle speed.

In a case in which the other vehicle in the adjacent lane adjacent to the own vehicle lane turns on the turn signal on the side of the own vehicle lane, deceleration is performed in the own vehicle in preparation for the other vehicle cutting in front of the own vehicle. However, in this case, when excessive deceleration is performed in the own vehicle, the own vehicle may excessively approach a following vehicle behind the own vehicle or re-acceleration of the own vehicle may be inhibited if the other vehicle does not cut in front of the own vehicle. In this regard, in the above-described configuration, when the other vehicle in the adjacent lane adjacent to the own vehicle lane turns on the turn signal on the side of the own vehicle lane and the other vehicle speed is lower than the own vehicle speed, the deceleration control of the own vehicle is performed with the speed obtained by the predetermined offset speed being added to the other vehicle speed as the target speed. In this case, the speed obtained by the offset speed being added to the other vehicle speed is set as the target speed with reference to the other vehicle speed. Therefore, when the own vehicle is decelerated in accompaniment with the turn signal of the other vehicle being turned on, the deceleration control of the own vehicle is performed at a degree of deceleration in which the offset speed is a maximum speed difference. That is, the own vehicle speed is controlled at a speed that is higher than the other vehicle speed by the offset speed. Excessive deceleration of the own vehicle can be suppressed while a state of approach of the own vehicle to the other vehicle is controlled. Consequently, the deceleration of the own vehicle can be appropriately performed when the other vehicle in the adjacent lane suggests cutting in toward the own vehicle lane side.

An embodiment implementing a vehicle control apparatus of the present disclosure will hereinafter be described with reference to the drawings. According to the present embodiment, a travel assistance system that provides vehicle travel assistance is constructed in a vehicle such as a passenger vehicle, a truck, or a bus.

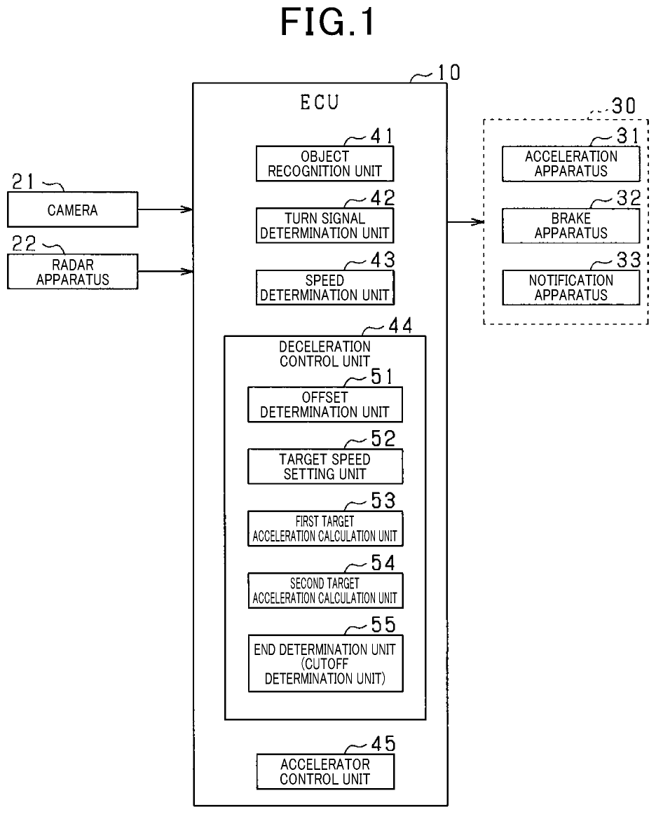

As shown in FIG. 1, a vehicle control system according to the present embodiment includes an electronic control unit (ECU) 10 serving as the vehicle control apparatus, a camera 21, a radar apparatus 22, and a controlled apparatus 30. The controlled apparatus 30 includes an accelerator apparatus 31, a brake apparatus 32, and a notification apparatus 33.

The camera 21 is an on-board camera composed of a known charge-coupled device (CCD) camera and the like. The camera 21 is mounted in a cabin of an own vehicle near an upper portion of a front windshield. The camera 21 is capable of capturing images of a predetermined imaging range ahead of the own vehicle. The camera 21 continuously captures images at a time interval (predetermined cycle) set in advance and transmits the captured images to the ECU 10 at the predetermined cycle. The camera 21 may be a monocular camera or a stereo camera.

The radar apparatus 22 is a distance measurement apparatus using millimeter-wave, high-frequency signals as transmission waves. For example, the radar apparatus 22 may be mounted in each of a front end and a rear end of the own vehicle, and measures a distance to an object in the vicinity of the own vehicle. Specifically, the radar apparatus 22 transmits a probe wave at a predetermined cycle and receives a reflected wave through a plurality of antenna. The radar apparatus 22 measures the distance to the object based on a transmission time of the probe wave and a reception time of the reflected wave. The radar apparatus 22 also calculates an orientation of the object based on a phase difference between the reflected waves received by the plurality of antennas. A relative position of the object to the own vehicle can be identified by the calculation of the distance to the object and the orientation of the object.

The ECU 10 is an electronic control apparatus including a known microcomputer composed of a central processing unit (CPU) serving as a processor, a read-only memory (ROM), a random access memory (RAM), a flash memory, and the like. The microcomputer provides various computing functions. The functions provided by the microcomputer can be provided by software recorded in a tangible memory apparatus and a computer that executes the software, software alone, hardware alone, or a combination thereof. The microcomputer may execute a program stored in, for example, a non-transitory computer-readable tangible storage medium serving as a storage unit provided in the microcomputer. The program may include, for example, a program related to an object recognition process for recognizing an object in the vicinity of the own vehicle, and a process for avoiding a collision with the object in the vicinity of the own vehicle or mitigating damage in the event of a collision. A method corresponding to the program is performed by the program being executed. For example, the storage unit may be a non-volatile memory. Here, for example, the program stored in the storage unit can be updated over a network such as the Internet.

The ECU 10 acquires object detection information from each of the camera 21 and the radar apparatus 22, and recognizes an object in the vicinity of the own vehicle based on these pieces of information. Specifically, the ECU 10 calculates a relative position, a presence region, and the like of the object as image information, using the distance to the object and the orientation of the object calculated from the camera image. In addition, the ECU 10 calculates the relative position, the presence area, and the like of the object as radar information, using the distance to the object and the orientation of the object included in the distance information acquired from the radar apparatus 22. The ECU 10 then recognizes the object by integrating (fusing) the image information and the radar information. At this time, the object is recognized based on overlapping between the presence region of the object included in the image information and the presence region of the object included in the radar information. However, according to the present embodiment, a method for object recognition is arbitrary. For example, the object can be recognized based on the object detection information from the camera 21 alone or the object detection information from the radar apparatus 22 alone, of the object detection information from the camera 21 and the radar apparatus 22.

The ECU 10 performs adaptive cruise control (ACC) as a travel assistance control for the own vehicle. Specifically, the ECU 10 performs constant-speed travel control to cause the own vehicle to travel at a constant speed, at a target speed (preset speed) set by the driver. In addition, in a case in which a preceding vehicle traveling ahead of the own vehicle in the travelling direction is present, the ECU 10 performs following travel control to cause the own vehicle to travel so as to follow the preceding vehicle while maintaining a predetermined target inter-vehicle distance to the preceding vehicle. In this case, during execution of the ACC control, the ECU 10 searches for a preceding vehicle to be followed ahead of the own vehicle in the travelling direction. Should a preceding vehicle not be present, the own vehicle travels at a constant speed, at the target speed. In addition, should the preceding vehicle be present, the own vehicle travels with the target speed as an upper limit speed while maintaining the inter-vehicle distance to the preceding vehicle at the target inter-vehicle distance. At this time, to perform speed control of the own vehicle, the ECU 10 controls the speed by adjusting driving force and braking force of the own vehicle using the controlled apparatus 30. As a result of the ACC control, vehicle speed control in a state in which the driver is not depressing an accelerator pedal is possible.

According to the present embodiment, the accelerator apparatus 31 and the brake apparatus 32 are mounted in the own vehicle as the controlled apparatus 30. The accelerator apparatus 31 is an engine or a motor serving as a vehicle power source. During accelerator operation by the driver, the accelerator apparatus 31 applies driving force to the own vehicle in response to a control command from the ECU 10. The brake apparatus 32 is provided in each wheel of the own vehicle. During brake operation by the driver, braking force is applied to the own vehicle in response to a control command from the ECU 10.

Here, the ACC control can be turned on and off by the driver. For example, the ECU 10 may perform the ACC control as a result of the driver turning on a set switch. In addition, when a predetermined cancellation condition is met, such as the driver turning off the set switch, the ACC control by the ECU 10 is stopped.

The notification apparatus 33 includes a voice apparatus that issues a notification by voice and a display apparatus that issues a notification by display. The ECU 10 issues a warning and the like using the notification apparatus 33 based on a traveling state of the own vehicle for the purpose of avoiding danger and assisting driving.

Furthermore, according to the present embodiment, in a case in which another vehicle cuts in front of the own vehicle, the travel speed of the own vehicle is controlled based on the cut-in behavior of the other vehicle. Speed control of the own vehicle when another vehicle cuts in will be described in detail below.

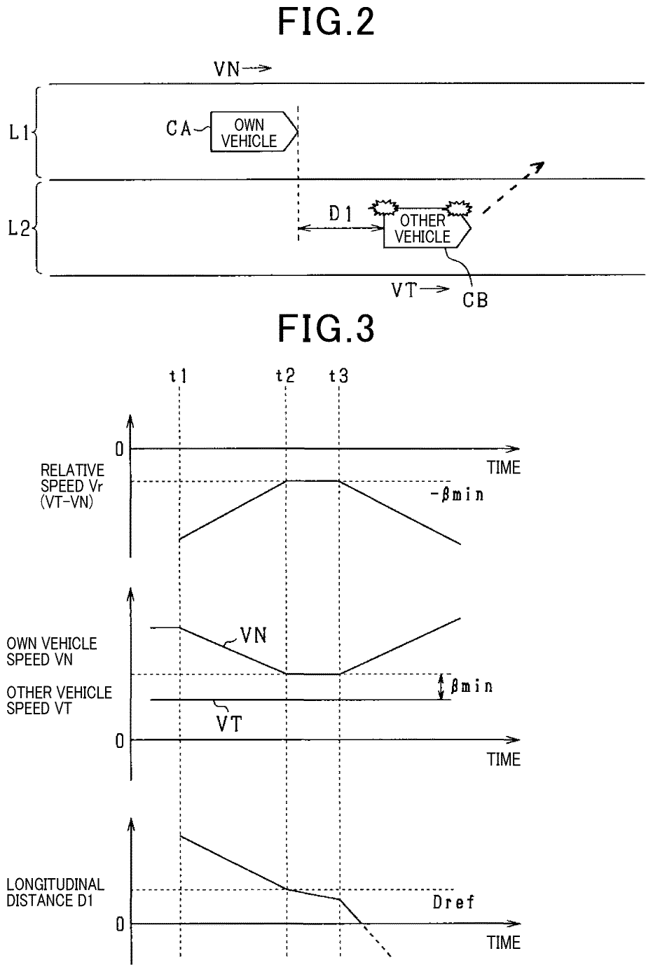

FIG. 2 is a diagram of a scene in which another vehicle cuts in. In FIG. 2, a own vehicle CA is traveling in an own vehicle lane L1, and another vehicle CB is traveling in an adjacent lane L2 adjacent to the own vehicle lane L1. The own vehicle lane L1 and the adjacent lane L2 are traffic lanes of which vehicle travelling directions are the same. The lanes L1 and L2 are demarcated by lane markers such as a white line. The travel speed of the own vehicle CA is an own vehicle speed VN. The travel speed of the other vehicle CB is another vehicle speed VT. A distance between the own vehicle CA and the other vehicle CB in the vehicle travelling direction is a longitudinal distance D1.

In this cut-in scene, the other vehicle CB is traveling ahead of the own vehicle CA, and the other vehicle speed VT is lower than the own vehicle speed VN. In addition, as a result of the turn signal on the side of the own vehicle lane L1 (left side of the other vehicle CB) being turned on in the other vehicle CB, a suggestion of a cut-in toward the own vehicle lane L1 side is made. After the other vehicle CB turns on the turn signal, the own vehicle CA performs deceleration control under an assumption that the other vehicle CB will change lanes and cut in front of the own vehicle CA.

However, the other vehicle CB does not necessarily cut in front of the own vehicle CA even when the turn signal of the other vehicle CB is turned on. The own vehicle CA may be unnecessarily decelerated in a scene in which the other vehicle CB does not actually cut in front of the own vehicle CA. For example, in a case in which the other vehicle CB cuts in behind the own vehicle CA after turning on the turn signal, or a case in which the other vehicle CB erroneously turns on the turn signal, deceleration of the own vehicle CA is unnecessary and excessive deceleration is performed. Taking this into consideration, according to the present embodiment, the own vehicle CA performs appropriate deceleration control while suppressing excessive deceleration when the other vehicle CB in the adjacent lane L2 changes lanes toward the own vehicle L1 side.

FIG. 1 shows a configuration for performing deceleration control in the ECU 10. FIG. 3 is a time chart of an overview of the deceleration control of the own vehicle CA after the other vehicle CB turns on the turn signal. The deceleration control performed by the ECU 10 will be described in detail below with reference to FIG. 3. Here, in FIG. 3, the other vehicle speed VT may arbitrarily vary but is a constant value herein.

As shown in FIG. 1, the ECU 10 includes an object recognition unit 41, a turn signal determination unit 42, a speed determination unit 43, a deceleration control unit 44, and an acceleration control unit 45.

The object recognition unit 41 recognizes an object present in the vicinity of the own vehicle CA using the detection information from the camera 21 and the radar apparatus 22. As a result, the object recognition unit 41 recognizes the other vehicle CB traveling in the adjacent lane L2. Recognition information regarding the other vehicle CB includes information on clearance between the own vehicle CA and the other vehicle CB, and information on the relative speed between the own vehicle CA and the other vehicle CB.

The turn signal determination unit 42 determines that the turn signal of the other vehicle CB traveling in the adjacent lane L2 is turned on on the side of the own vehicle lane L1. Specifically, for example, the turn signal determination unit 42 may determine that the turn signal is turned on in the other vehicle CB using the camera image and analyzing the other vehicle CB in the image.

The speed determination unit 43 determines that the other vehicle speed VT is lower than the own vehicle speed VN. In this case, the speed determination unit 43 determines that the own vehicle CA is approaching the other vehicle CB in the vehicle travelling direction along the longitudinal direction of the road.

When the turn signal determination unit 42 determines that the turn signal is on in the other vehicle CB and the speed determination unit 43 determines that the other vehicle speed VT is lower than the own vehicle speed VN, the deceleration control unit 44 performs the deceleration control of the own vehicle CA by setting a speed (VT+β) obtained by adding a predetermined offset speed β to the other vehicle speed VT as a target deceleration speed. In FIG. 3, at timing t1, the turn signal of the other vehicle CB is turned on, and the own vehicle speed VN and the other vehicle speed VT are VN>VT. Then, from timing t1, the deceleration control of the own vehicle CA is started.

The deceleration control unit 44 includes an offset setting unit 51, a target speed setting unit 52, a first target acceleration calculation unit 53, a second target acceleration calculation unit 54, and an end determination unit 55.

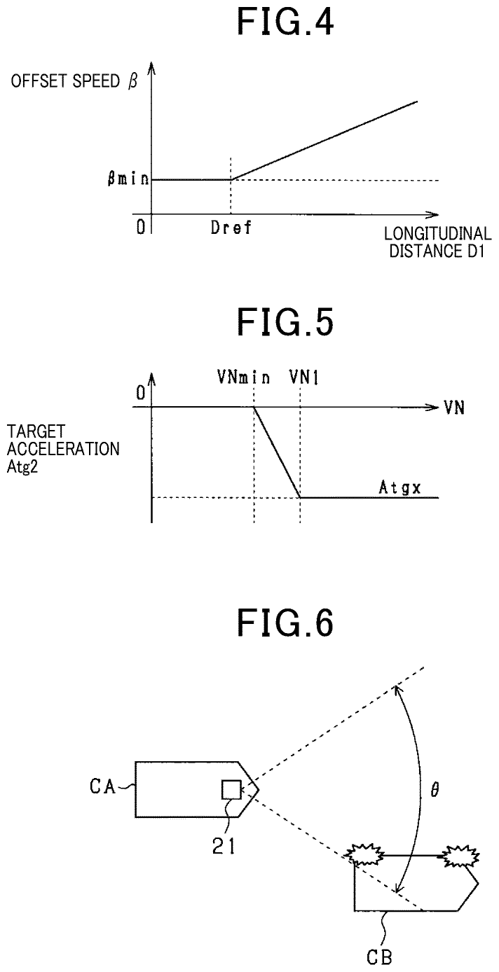

The offset setting unit 51 sets the offset speed β based on the longitudinal distance D1 between the own vehicle CA and the other vehicle CB. The offset speed β is a differential speed for prescribing a target value (target deceleration speed) of the own vehicle speed VN at a speed greater than the other vehicle speed VT, with reference to the other vehicle speed VT. Specifically, using a relationship in FIG. 4, the offset setting unit 51 sets the offset speed β to an offset-speed lower limit value βmin when the longitudinal distance D1 is shorter than a predetermined reference distance Dref, and set the offset speed β to a smaller value (that is, a value closer to βmin) as the longitudinal distance D1 becomes shorter when the longitudinal distance D1 is longer than the predetermined reference distance Dref. For example, the reference distance Dref may be 10 m. However, for example, the reference distance Dref may be a distance within a range of 5 m to 15 m.

The deceleration control unit 44 performs the deceleration control of the own vehicle CA using the offset speed β set by the offset setting unit 51. At this time, upon the longitudinal distance D1 being shortened to the reference distance Dref after the deceleration control of the own vehicle CA is started in accompaniment with the turn signal of the other vehicle CB being turned on, the deceleration control unit 44 performs constant relative-speed control to keep the relative speed between the own vehicle CA and the other vehicle CB constant. In this constant relative-speed control, the own vehicle speed VN is controlled at a speed at which a relative speed Vr to the other vehicle CB remains constant at the offset-speed lower limit value βmin.

The target speed setting unit 52 sets a target speed Vtg (target deceleration speed) by adding the offset speed β set by the offset setting unit 51 and the current other vehicle speed VT. That is, Vtg=VT+β.

The first target acceleration calculation unit 53 calculates a first target acceleration Atg1 of the own vehicle CA based on a speed deviation ΔV between the target speed Vtg set by the target speed setting unit 52 and the current own vehicle speed VN. At this time, the first target acceleration Atg1 is calculated as a value obtained by the speed deviation ΔV being multiplied by a predetermined gain G that is a positive value (Atg1=G×ΔV).

The second target acceleration calculation unit 54 calculates a second target acceleration Atg2 of the own vehicle CA based on the own vehicle speed VN. At this time, the second target acceleration Atg2 may be set using a relationship shown in FIG. 5. That is, in a speed range in which the own vehicle speed VN is greater than a lower limit speed VNmin prescribed in advance, the second target acceleration Atg2 is set as a negative acceleration. In a speed range in which the own vehicle speed VN is less than the lower limit speed VNmin, the second target acceleration Atg2 is set to zero. In addition, in a speed range in which the own vehicle speed VN is greater than the lower limit speed VNmin, a minimum acceleration Atgx (maximum acceleration on the negative side) is set as the second target acceleration Atg2. In a speed range in which the vehicle speed VN is between VNmin to VN1, the second target acceleration Atg2 is set so as to gradually change based on the own vehicle speed VN.

As a result of the relationship in FIG. 5, deceleration of the own vehicle CA is permitted until the own vehicle speed VN decreases to the lower limit speed VNmin. After the own vehicle speed VN decreases to the lower limit speed VNmin, further deceleration is suppressed by the target acceleration of the own vehicle CA becoming zero. That is, the own vehicle speed VN is essentially lower-limit guarded by the lower limit speed VNmin. For example, the lower limit speed VNmin may be 15 km/h. However, for example, the lower limit speed VNmin may be any value within a range of 10 km/h to 205 km/h.

Then, the deceleration control unit 44 performs the deceleration control of the own vehicle CA using the target acceleration that is the greater of the first target acceleration Atg1 calculated by the first target acceleration calculation unit 53 and the second target acceleration Atg2 calculated by the second target acceleration calculation unit 54. As a result, a rate of change over time of the own vehicle speed VN is controlled. The second target acceleration Atg2 also serves as a lower limit value for acceleration to lower-limit guard the acceleration of the own vehicle CA.

In FIG. 3, during a period from timing t1 to t2, the longitudinal distance D1 between the own vehicle CA and the other vehicle CB gradually decreases due to the deceleration control of the own vehicle CA. In this case, the relative speed Vr gradually increases as a result of the offset speed β gradually decreasing in accompaniment with the decrease in longitudinal distance D1.

At timing t2, the longitudinal distance D1 becomes the reference distance Dref. At and after timing t2, the offset speed β is maintained at the offset-speed lower limit value βmin. As a result, after the own vehicle CA approaches the other vehicle CB to the reference distance Dref, the constant relative-speed control is performed with the own vehicle speed VN set to a speed at which the relative speed Vr to the other vehicle CB remains constant at the offset-speed lower limit value βmin.

During a constant relative-speed period (period from t2 to t3), the own vehicle speed VN is in a state of being controlled at an intended speed. In this state, a determination regarding whether the other vehicle CB is actually cutting in toward the own vehicle lane L1 side or waiting for the own vehicle CA to pass without cutting in toward the own vehicle lane L1 side can be made. That is, the constant relative-speed period is a period during which the driver of the own vehicle CA is capable of waiting and seeing with ease the movement of the other vehicle CB in which the turn signal is turned on. In this case, appropriate responses are possible for both deceleration of the own vehicle CA in response to the other vehicle CB actually cutting in and re-acceleration of the own vehicle CA to overtake the other vehicle CB.

In addition, during the period from timing t1 to t2 in FIG. 3, the target speed Vtg is set based on the offset speed β and the other vehicle speed VT, and the first target acceleration Atg1 is calculated based on the speed deviation ΔV between the target speed Vtg and the actual own vehicle speed VN. Furthermore, the second target acceleration Atg2 is calculated based on the own vehicle speed VN. Then, the deceleration of the own vehicle CA is controlled using the target acceleration that is the greater (smaller negative acceleration) of the first target acceleration Atg1 and the second target acceleration Atg2. In this case, the acceleration of the own vehicle CA is adjusted based on the changes in the longitudinal distance D1 and the offset speed β, while a lower-limit guard is applied to the acceleration based on the own vehicle speed VN using the second target acceleration Atg2.

The end determination unit 55 determines that the deceleration control is ended as a result of any of the following conditions (i) to (iii) being fulfilled after the start of deceleration control accompanying the turn signal of the other vehicle CB being turned on.
(i) The state is such that cutoff in which a rear end portion of the other vehicle CB becomes unrecognizable from a recognizable state occurs in an image captured by the camera 21 (cutoff determination unit).
(ii) A predetermined amount of time Tx elapses from the start of deceleration control accompanying the turn signal of the other vehicle CB being turned on.
(iii) The turn signal is turned off in the other vehicle CB.

The deceleration control is ended in accompaniment with the earliest fulfillment of any of these conditions.

Additional information on the cutoff determination is as follows. FIG. 6 is a diagram of the state in which cutoff of the other vehicle CB occurs. In FIG. 6, a portion of the other vehicle CB is outside a detection range θ of the camera 21 ahead of the own vehicle CA as a result of the own vehicle CA approaching the other vehicle CB in the vehicle travelling direction. Consequently, the state is such that cutoff of the rear end portion of the other vehicle CB occurs in the camera image. Presence and absence of cutoff may be determined based on a shape, dimensions in a front-rear direction, and the like of the other vehicle CB recognized from the images captured by the camera 21. Here, cutoff of the other vehicle CB may be determined to have occurred based on a rear turn signal of the other vehicle CB being cut off.

Determining that the state is such that cutoff of the other vehicle CB occurs can also be determined based on the longitudinal distance D1 between the own vehicle CA and the other vehicle CB being shortened to a predetermined distance at which cutoff of the rear end portion of the other vehicle CB is presumed to occur.

In addition, when the end determination is performed based on the elapse of the predetermined amount of time Tx after deceleration control, the elapsed time from the start of deceleration control accompanying the turn signal of the other vehicle CB being turned on is measured (time measuring unit). For example, the predetermined amount of time Tx may be about 15 seconds. Here, the amount of time used for the end determination regarding deceleration control may be the amount of time from the start of constant relative-speed control after the start of deceleration control. In this case, the deceleration control is ended upon elapse of a predetermined amount of time Ty after the start of constant relative-speed control. For example, the predetermined amount of time Ty may be about 5 seconds.

The above-described conditions are for determining a scene in which, although the turn signal is turned on in the other vehicle CB, the other vehicle CB does not subsequently cut in front of the own vehicle CA. In this case, because the own vehicle CB is assumed to cut in behind the own vehicle CA in the scene in which cutoff of the other vehicle CB occurs, the deceleration control is ended. In addition, when the predetermined amount of time Tx elapses after the turn signal of the other vehicle CB is turned on or when the turn signal of the other vehicle CB is turned off, because the other vehicle CB is assumed to no longer have the intention to change lanes, the deceleration control is ended.

The deceleration control unit 44 ends the deceleration control when the end determination unit 55 determines that the deceleration control is to be ended.

The acceleration control unit 45 accelerates the own vehicle CA after the end of deceleration control. At this time, in ACC control mode, acceleration of the own vehicle CA may be performed by constant-speed travel control or following travel control. As a result, the own vehicle speed VN returns to the speed before the turn signal of the other vehicle CB is turned on. However, when the own vehicle CA is not in ACC control mode, the own vehicle CA being accelerated by an acceleration operation by the driver to overtake the other vehicle CB can be considered.

In FIG. 3, at timing t3, the end condition for deceleration control is fulfilled and the deceleration control is ended. From timing t3, the own vehicle CA is accelerated. In this case, in the deceleration control before timing t3, the own vehicle speed VN is appropriately controlled relative to the other vehicle speed VT by excessive deceleration being suppressed. Therefore, from timing T3, prompt acceleration to overtake the other vehicle CB in the adjacent lane L2 is performed in the own vehicle CA.

Here, although not shown, in the case in which the other vehicle CB of which the turn signal is turned on changes lanes and cuts in front of the own vehicle CA, the inter-vehicle distance to the other vehicle CB in the own vehicle lane L1 decreases. Therefore, the inter-vehicle distance in the front-rear direction may be secured by deceleration being performed through collision avoidance control for the other vehicle CB. In the collision avoidance control, a collision prediction time (time to collision TTC) is calculated based on the inter-vehicle distance between the own vehicle CA and the other vehicle CB, and the relative speed between the own vehicle speed VN and the other vehicle speed VT. The own vehicle CA is decelerated based on the collision prediction time.

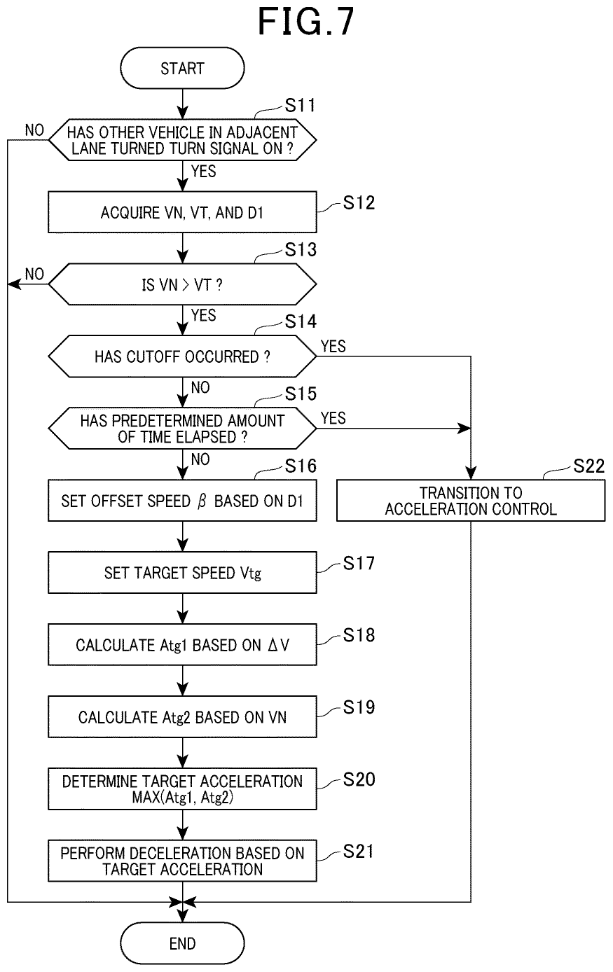

FIG. 7 is a flowchart of processing steps for vehicle speed control. The ECU 10 repeatedly performs the present process at a predetermined cycle.

In FIG. 7, at step S11, the ECU 10 determines whether the turn signal is turned on in the other vehicle CB traveling in the adjacent lane L2. When determined YES at step S11, the ECU 10 proceeds to following step S12. When determined NO at step S11, the ECU 10 temporarily ends the present process. At step S12, the ECU 10 acquires the own vehicle speed VN, the other vehicle speed VT, and the longitudinal distance D1 between the own vehicle CA and the other vehicle CB.

Subsequently, at step S13, the ECU 10 determines whether the other vehicle speed VT is lower than the own vehicle speed VN. When determined that the other vehicle speed VT is lower than the own vehicle speed VN, the ECU 10 proceeds to step S14.

At steps S14 and S15, the ECU 10 determines whether the end condition for deceleration control performed after the turn signal of the other vehicle CB is turned on is fulfilled. Specifically, at step S14, the ECU 10 determines whether the state is such that the rear end portion of the other vehicle CB is cut off. In addition, at step S15, the ECU 10 determines whether the predetermined amount of time Tx has elapsed from the start of deceleration control. Then, when determined NO at both steps S14 and S15, the ECU 10 proceeds to following step S16. In this case, the deceleration control is continued rather than ended.

At step S16, the ECU 10 sets the offset speed β based on the longitudinal distance D1 between the own vehicle CA and the other vehicle CB. For example, the offset speed β may be set using the relationship in FIG. 4. At step S17, the ECU 10 sets the target speed Vtg by adding the offset speed β set at step S16 and the current other vehicle speed VT. That is, Vtg=VT+β.

Subsequently, at step S18, the ECU 10 calculates the first target acceleration Atg1 of the own vehicle CA based on the speed deviation ΔV between the target speed Vtg and the current own vehicle speed VN. At step S19, the ECU 10 calculates the second target acceleration Atg2 of the own vehicle CA based on the own vehicle speed VN. For example, the second target acceleration Atg2 may be set using the relationship in FIG. 5. Then, at step S20, the ECU 10 determines the greater (smaller negative acceleration) of the first target acceleration Atg1 and the second target acceleration Atg2 to be the target acceleration used for deceleration control at this time.

At step S21, the ECU 10 performs the deceleration control of the own vehicle CA based on the target acceleration determined at step S20. As a result, the deceleration control of the own vehicle CA is performed with the speed (VT+β) obtained by the predetermined offset speed β being added to the other vehicle speed VT as the target deceleration speed.

Meanwhile, when determined YES at either of the steps S14 and S15, the ECU 10 proceeds to step S22. In this case, the ECU 10 ends the deceleration control and performs the acceleration control of the own vehicle CA at step S22.

According to the present embodiment described in detail above, the following excellent effects can be achieved.

When the other vehicle CB in the adjacent lane L2 turns on the turn signal on the own vehicle lane L1 side and the other vehicle speed VT is lower than the own vehicle speed VN, the deceleration control of the own vehicle CA is performed with the speed obtained by the offset speed β being added to the other vehicle speed VT as the target speed. In this case, the speed obtained by the offset speed β being added to the other vehicle speed VT is set as the target speed with reference to the other vehicle speed VT in the own vehicle CA. Therefore, when the own vehicle CA is decelerated in accompaniment with the turn signal of the other vehicle CB being turned on, the deceleration control of the own vehicle CA is performed at a degree of deceleration in which the offset speed β is a maximum speed difference. That is, the own vehicle speed VN is controlled at a speed that is higher than the other vehicle speed VT by the offset speed β. Excessive deceleration of the own vehicle CA can be suppressed while a state of approach of the own vehicle CA to the other vehicle CB is controlled. Consequently, the deceleration of the own vehicle CA can be appropriately performed when the other vehicle CB in the adjacent lane L2 suggests cutting in toward the own vehicle lane L1 side.

A likelihood of contact between the own vehicle CA and the other vehicle CB when the other vehicle CB cuts in toward the own vehicle lane L1 from the adjacent lane L2 changes depending on the longitudinal distance D1 between the own vehicle CA and the other vehicle CB. Taking this into consideration, the offset speed β is set based on the longitudinal distance D1 between the own vehicle CA and the other vehicle CB, and the deceleration control of the own vehicle CA is performed using the offset speed β. As a result, the travel speed of the own vehicle CA can be appropriately controlled while the speed difference (relative speed) with the other vehicle CB is changed depending on the extent to which the other vehicle CB serving as a cut-in vehicle approaches the own vehicle CA.

The configuration is such that the offset speed β is set to the offset-speed lower limit value βmin when the longitudinal distance D1 between the own vehicle CA and the other vehicle CB is shorter than the predetermined reference distance Dref, and the offset speed β is set to a smaller value as the longitudinal distance D1 becomes shorter when the longitudinal distance D1 is longer than the reference distance Dref. In this case, as a result of the reference distance Dref for the longitudinal distance D1 and the offset-speed lower limit value βmin being prescribed, the constant relative-speed control is performed once the own vehicle CA approaches the other vehicle CB to the reference distance Dref. The movement of the other vehicle CB can be monitored with ease while the own vehicle CA travels with a sense of constant speed relative to the other vehicle.

Once the own vehicle CA decelerates after the turn signal of the other vehicle CB is turned on and the longitudinal distance D1 is shorted to the reference distance Dref, the constant relative-speed control in which the relative speed Vr between the own vehicle CA and the other vehicle CB is held constant at the offset-speed lower limit value βmin is performed. As a result, whether the other vehicle CB is actually cutting in towards the own vehicle lane L1 side or waiting for the own vehicle CA to pass without cutting in toward the own vehicle lane L1 side can be determined in a state in which the own vehicle speed VN is controlled at an intended speed during the constant relative-speed period. In this case, both the deceleration of the own vehicle CA in response to the actual cut-in by the other vehicle CB and the acceleration of the own vehicle CA to overtake the other vehicle CB can be performed.

The target speed Vtg is set by adding the current other vehicle speed VT and the offset speed β. In addition, the first target acceleration Atg1 of the own vehicle CA is calculated based on the speed deviation ΔV between the target speed Vtg and the current own vehicle speed VN. Then, the deceleration control of the own vehicle CA is performed using the first target acceleration Atg1. In this case, when the own vehicle CA is decelerated after the turn signal of the other vehicle CB is turned on, the acceleration of the own vehicle CA can be adjusted based on the changes in the longitudinal distance D1 and the offset speed β. Consequently, the own vehicle CA can be appropriately decelerated based on the longitudinal distance D1 to the other vehicle CB while unease experienced by the driver of the own vehicle CA is suppressed as the own vehicle CA approaches the other vehicle CB. At this time, the acceleration control is performed while reflecting longitudinal behavior of the other vehicle CB. Therefore, even if longitudinal behavior of the other vehicle CB changes, deceleration control that follows the changes can be implemented.

The deceleration control of the own vehicle CA is performed using the target acceleration having the greater value of the first target acceleration Atg1 calculated based on the speed deviation ΔV between the target speed Vtg and the own vehicle speed VN, and the second target acceleration Atg2 calculated based on the own vehicle speed VN. In this case, excessive deceleration of the own vehicle CA can be appropriately suppressed while redundancy in deceleration control is improved.

When the second target acceleration Atg2 is calculated based on the vehicle speed VN, the second target acceleration Atg2 is a negative acceleration when the own vehicle speed VN is equal to or greater than the lower limit speed VNmin, and zero when the own vehicle speed VN is less than the lower limit speed VNmin. As a result of this configuration, the own vehicle speed VN excessively decreasing against the intention of the driver can be suppressed while the target acceleration is limited to a maximum of zero based on the own vehicle speed VN.

When the own vehicle CA is decelerated in preparation for cut-in by the other vehicle CB of which the turn signal is turned on, should the other vehicle CB continue traveling in the adjacent lane L2, the rear end portion (such as a rear turn signal) of the other vehicle CB eventually being cut off from the image captured by the camera 21 of the own vehicle CA can be considered. In this case, in the state in which the rear end portion of the other vehicle CB is cut off, the other vehicle CB is predicted to cut in behind the own vehicle CA. Therefore, the deceleration control is ended. As a result, acceleration to overtake the other vehicle CB can be appropriately performed.

After the start of deceleration control, the deceleration control is ended based on the earlier of the state being determined to be such that cutoff of the rear end portion of the other vehicle CB occurs and the elapsed time from the start of deceleration control reaching the predetermined amount of time Tx. In this case, even should a state in which cutoff of the other vehicle CB does not occur continue, the deceleration control being excessively continued can be suppressed. As a result, transition to a next scene, such as overtaking the other vehicle CB, can be appropriately performed.

The own vehicle CA is accelerated by constant-speed travel control or following travel control after the end of deceleration control accompanying the turn signal of the other vehicle CB being turned on. As a result, the own vehicle CA can promptly overtake the other vehicle CB after determining that the other vehicle CB is not cutting in toward the own vehicle lane L1 after the turn signal is turned on.

### Other Embodiments

For example, the above-described embodiment may be modified in the following manner.

The lower limit speed allowing appropriate travel is thought to change during deceleration in preparation for cut-in by the other vehicle in circumstances in which the road on which the own vehicle CA travels is a curved road or an uphill road. Specifically, during travel on a curved road, the own vehicle CA may not be able to stably travel on the curved road should the own vehicle speed VN decrease to the same lower limit speed VNmin as that for a straight road. In addition, during travel on an uphill road, the own vehicle CA may not be able to stably travel on the uphill road should the own vehicle speed VN decrease to the same lower limit speed VNmin as that for a flat road. Taking this into consideration, the lower limit speed VNmin may be set based on road configuration information.

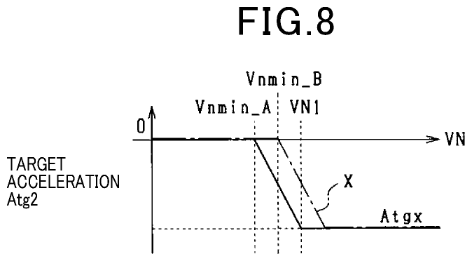

Specifically, the ECU 10 in FIG. 1 may include an information acquiring unit that acquires the road configuration information related to a configuration of the road on which the own vehicle CA travels and a lower-limit-speed setting unit that sets the lower limit speed VNmin based on the road configuration information. Then, the second target acceleration calculation unit 54 calculates the second target acceleration Atg2 using the lower limit speed VNmin set based on the road configuration information. In this case, for example, the second target acceleration Atg2 may be set using a relationship in FIG. 8. In FIG. 8, a relationship X shown by a single-dot chain line is added to the relationship in FIG. 5. The relationship X is a relationship used when the road on which the own vehicle CA travels is a curved road or an uphill road. The lower limit speed VNmin is VNmin_B that is higher than VNmin_A used on a straight, flat road.

As a result of the present configuration, appropriate deceleration control can be performed when the other vehicle CB suggests cut-in on a curved road or an uphill road.

According to the above-described embodiment, in the deceleration control performed after the turn signal of the other vehicle CB is turned on, the first target acceleration Atg1 and the second target acceleration Atg2 are calculated, and the deceleration control of the own vehicle CA is performed using the target acceleration having the greater value of the first target acceleration Atg1 and the second target acceleration Atg2. However, this may be modified. For example, the configuration may be such that, of the first target acceleration Atg1 and the second target acceleration Atg2, only the first target acceleration Atg1 is calculated. In this configuration, in the deceleration control in FIG. 7, the target acceleration Atg1 of the own vehicle CA is calculated based on the speed deviation ΔV between the target speed Vtg and the current vehicle speed VN (step S18), and the deceleration control of the own vehicle CA is performed based on the target acceleration Atg1 (step S21). At this time, during execution of the deceleration control, the lower limit of the own vehicle speed VN may be limited so as not to fall below the predetermined lower limit speed VNmin prescribed in advance.

A control apparatus and a method thereof described in the present disclosure may be implemented by a dedicated computer that is provided such as to be configured by a processor and a memory, the processor being programmed to provide one or more functions that are implemented by a computer program. As one alternative, the control apparatus and a method thereof described in the present disclosure may be implemented by a dedicated computer that is provided by a processor being configured by one or more dedicated hardware logic circuits. As another alternative, the control apparatus and a method thereof described in the present disclosure may be implemented by oner or more dedicated computers. The dedicated computer may be configured by a combination of a processor that is programmed to provide one or more functions, a memory, and a processor that is configured by one or more hardware logic circuits. In addition, the computer program may be stored in a non-transitory, computer-readable, tangible storage medium that can be read by a computer as instructions performed by the computer.

Technical ideas extracted from the above-described embodiments are described below.

### Aspect 1

A vehicle control apparatus (10) capable of controlling a travel speed of an own vehicle, the vehicle control apparatus including: at least one of (i) a circuit and (ii) a processor with a memory storing computer program code executable by the processor, the at least one of the circuit and the processor configured to implement: a turn signal determination unit (42) that determines whether another vehicle is traveling in an adjacent lane adjacent to an own vehicle lane in which the own vehicle travels and the other vehicle has turned on a turn signal on a side of the own vehicle lane; a speed determination unit (43) that determines whether another vehicle speed that is a travel speed of the other vehicle is lower than an own vehicle speed that is the travel speed of the own vehicle; and a deceleration control unit (44) that performs deceleration control of the own vehicle with a speed obtained by adding a predetermined offset speed to the other vehicle speed as a target speed, in response to the turn signal determination unit determining that the turn signal in the other vehicle is turned on and the speed determination unit determining that the other vehicle speed is lower than the own vehicle speed.

### Aspect 2

The vehicle control apparatus according to the aspect 1, in which: the deceleration control unit includes an offset setting unit (51) that sets the offset speed based on a longitudinal distance that is a distance between the own vehicle and the other vehicle in an travelling direction of the own vehicle; and the deceleration control unit performs the deceleration control of the own vehicle using the offset speed set by the offset setting unit.

### Aspect 3

The vehicle control apparatus according to the aspect 2, in which: the offset setting unit sets the offset speed to an offset-speed lower limit value in response to the longitudinal distance being shorter than a reference distance and sets the offset speed to a smaller value as the longitudinal distance becomes shorter in response to the longitudinal distance being longer than the reference distance.

### Aspect 4

The vehicle control apparatus according to the aspect 3, in which: the deceleration control unit performs constant relative-speed control in which the own vehicle speed is set to a speed at which a relative speed to the other vehicle is held constant at the offset-speed lower limit value upon the longitudinal distance being shortened to the reference distance after the deceleration control of the own vehicle is started in accompaniment with the turn signal of the other vehicle being turned on.

### Aspect 5

The vehicle control apparatus according to any one of the aspects 2 to 4, in which: the deceleration control unit includes a target speed setting unit (52) that sets the target speed by adding the offset speed set by the offset setting unit and a current other vehicle speed, a target acceleration calculation unit (53) that calculates a target acceleration of the own vehicle based on a speed deviation between the target speed set by the target speed setting unit and a current own vehicle speed; and the deceleration control unit performs the deceleration control of the own vehicle using the target acceleration.

### Aspect 6

The vehicle control apparatus according to the aspect 5, in which: the deceleration control unit includes a first target acceleration calculation unit (53) configuring the target acceleration calculation unit, and a second target acceleration calculation unit (54) that calculates a second target acceleration of the own vehicle based on the own vehicle speed; and the deceleration control unit performs the deceleration control of the own vehicle using a target acceleration having a greater value of the first target acceleration and the second target acceleration.

### Aspect 7

The vehicle control apparatus according to the aspect 6, in which: the second target acceleration calculation unit sets the second target acceleration to a negative acceleration in response to the own vehicle speed being equal to or greater than a predetermined lower limit speed, and sets the second target acceleration to zero in response to the own vehicle speed being less than the lower limit speed.

### Aspect 8

The vehicle control apparatus according to any one of the aspects 1 to 5, in which: the deceleration control unit limits a lower limit of the own vehicle speed so as not to fall below a predetermined lower limit speed prescribed in advance during execution of the deceleration control.

### Aspect 9

The vehicle control apparatus according to the aspect 7 or 8, further including: an information acquiring unit that acquires road configuration information related to a configuration of a road on which the own vehicle travels; and a lower-limit-speed setting unit that sets the lower limit speed based on the road configuration information.

### Aspect 10

The vehicle control apparatus according to any one of the aspects 1 to 9, in which: the vehicle control apparatus is applied to a vehicle including a camera (21) that captures an image ahead of the vehicle, and recognizes the other vehicle traveling in the adjacent lane based on the image captured by the camera; the vehicle control apparatus includes a cutoff determination unit (55) that determines whether a state is such that cutoff in which a rear end portion of the other vehicle becomes unrecognizable from a recognizable state occurs in the image captured by the camera; and the deceleration control unit ends the deceleration control in response to the cutoff determination unit determining that the state is such that cutoff occurs after the start of the deceleration control.

### Aspect 11

The vehicle control apparatus according to the aspect 10, further including: a time measuring unit that measures elapsed time from a start of deceleration control accompanying the turn signal of the other vehicle being turned on, in which the deceleration control unit ends the deceleration control after the deceleration control is started based on the earlier of the state being determined to be such that cutoff occurs by the cutoff determination unit and the elapsed time measured by the time measuring unit reaching a predetermined amount of time.

### Aspect 12

The vehicle control apparatus according to the aspect 10 or 11, in which: the vehicle control apparatus is capable of performing at least either of constant-speed travel control to cause the own vehicle to travel at a predetermined preset speed and following travel control to cause the own vehicle to travel so as to follow a preceding vehicle traveling ahead of the own vehicle, and the vehicle control apparatus includes an acceleration control unit (45) that accelerates the own vehicle by the constant-speed travel control or the following travel control in accompaniment with the deceleration control being ended.

### Aspect 13

A non-transitory computer-readable storage medium storing therein a program applied to a vehicle control apparatus capable of controlling a travel speed of an own vehicle, the program causing a processor to perform processes including: a turn signal determination process for determining that another vehicle is traveling in an adjacent lane adjacent to an own vehicle lane in which the own vehicle travels and the other vehicle has turned on a turn signal on a side of the own vehicle lane; a speed determination process for determining that another vehicle speed that is a travel speed of the other vehicle is lower than an own vehicle speed that is the travel speed of the own vehicle; and a deceleration control process for performing deceleration control of the own vehicle with a speed obtained by a predetermined offset speed being added to the other vehicle speed as a target speed, in response to the turn signal in the other vehicle being determined to be turned on in the turn signal determination process and the other vehicle speed being determined to be lower than the own vehicle speed in the speed determination process.

### Aspect 14

A vehicle control method for controlling a travel speed of an own vehicle, the vehicle control method including: determining that another vehicle is traveling in an adjacent lane adjacent to an own vehicle lane in which the own vehicle travels and the other vehicle has turned on a turn signal on a side of the own vehicle lane; determining that another vehicle speed that is a travel speed of the other vehicle is lower than an own vehicle speed that is the travel speed of the own vehicle; and performing deceleration control of the own vehicle with a speed obtained by adding a predetermined offset speed to the other vehicle speed as a target speed, in response to the turn signal in the other vehicle being determined to be turned on and the other vehicle speed being determined to be lower than the own vehicle speed.

What is claimed is:

1. A vehicle control apparatus capable of controlling a travel speed of an own vehicle, the vehicle control apparatus comprising:
at least one of (i) a circuit and (ii) a processor with a memory storing computer program code executable by the processor, the at least one of the circuit and the processor configured to implement:
a turn signal determination unit that determines whether another vehicle is traveling in an adjacent lane adjacent to an own vehicle lane in which the own vehicle travels and the other vehicle has turned on a turn signal on a side of the own vehicle lane;
a speed determination unit that determines whether another vehicle speed that is a travel speed of the other vehicle is lower than an own vehicle speed that is the travel speed of the own vehicle; and
a deceleration control unit that performs deceleration control of the own vehicle with a speed obtained by adding a predetermined offset speed to the other vehicle speed as a target speed, in response to the turn signal determination unit determining that the turn signal in the other vehicle is turned on and the speed determination unit determining that the other vehicle speed is lower than the own vehicle speed.

2. The vehicle control apparatus according to claim 1, wherein:
the deceleration control unit comprises
an offset setting unit that sets the offset speed based on a longitudinal distance that is a distance between the own vehicle and the other vehicle in an travelling direction of the own vehicle; and
the deceleration control unit performs the deceleration control of the own vehicle using the offset speed set by the offset setting unit.

3. The vehicle control apparatus according to claim 2, wherein:
the offset setting unit sets the offset speed to an offset-speed lower limit value in response to the longitudinal distance being shorter than a reference distance and sets the offset speed to a smaller value as the longitudinal distance becomes shorter in response to the longitudinal distance being longer than the reference distance.

4. The vehicle control apparatus according to claim 3, wherein:
the deceleration control unit performs constant relative-speed control in which the own vehicle speed is set to a speed at which a relative speed to the other vehicle is held constant at the offset-speed lower limit value upon the longitudinal distance being shortened to the reference distance after the deceleration control of the own vehicle is started in accompaniment with the turn signal of the other vehicle being turned on.

5. The vehicle control apparatus according to claim 2, wherein:
the deceleration control unit comprises
a target speed setting unit that sets the target speed by adding the offset speed set by the offset setting unit and a current other vehicle speed,
a target acceleration calculation unit that calculates a target acceleration of the own vehicle based on a speed deviation between the target speed set by the target speed setting unit and a current own vehicle speed; and
the deceleration control unit performs the deceleration control of the own vehicle using the target acceleration.

6. The vehicle control apparatus according to claim 5, wherein:
the deceleration control unit comprises
a first target acceleration calculation unit configuring the target acceleration calculation unit, and
a second target acceleration calculation unit that calculates a second target acceleration of the own vehicle based on the own vehicle speed; and
the deceleration control unit performs the deceleration control of the own vehicle using a target acceleration having a greater value of the first target acceleration and the second target acceleration.

7. The vehicle control apparatus according to claim 6, wherein:
the second target acceleration calculation unit sets the second target acceleration to a negative acceleration in response to the own vehicle speed being equal to or greater than a predetermined lower limit speed, and sets the second target acceleration to zero in response to the own vehicle speed being less than the lower limit speed.

8. The vehicle control apparatus according to claim 5, wherein:
the deceleration control unit limits a lower limit of the own vehicle speed so as not to fall below a predetermined lower limit speed prescribed in advance during execution of the deceleration control.

9. The vehicle control apparatus according to claim 7, further comprising:
an information acquiring unit that acquires road configuration information related to a configuration of a road on which the own vehicle travels; and
a lower-limit-speed setting unit that sets the lower limit speed based on the road configuration information.

10. The vehicle control apparatus according to claim 8, further comprising:
an information acquiring unit that acquires road configuration information related to a configuration of a road on which the own vehicle travels; and
a lower-limit-speed setting unit that sets the lower limit speed based on the road configuration information.

11. The vehicle control apparatus according to claim 1, wherein:
the vehicle control apparatus is applied to a vehicle including a camera that captures an image ahead of the vehicle, and recognizes the other vehicle traveling in the adjacent lane based on the image captured by the camera;
the vehicle control apparatus comprises
a cutoff determination unit that determines whether a state is such that cutoff in which a rear end portion of the other vehicle becomes unrecognizable from a recognizable state occurs in the image captured by the camera; and
the deceleration control unit ends the deceleration control in response to the cutoff determination unit determining that the state is such that cutoff occurs after the start of the deceleration control.

12. The vehicle control apparatus according to claim 11, further comprising:
a time measuring unit that measures elapsed time from a start of deceleration control accompanying the turn signal of the other vehicle being turned on, wherein
the deceleration control unit ends the deceleration control after the deceleration control is started based on the earlier of the state being determined to be such that cutoff occurs by the cutoff determination unit and the elapsed time measured by the time measuring unit reaching a predetermined amount of time.

13. The vehicle control apparatus according to claim 11, wherein:
the vehicle control apparatus is capable of performing at least either of constant-speed travel control to cause the own vehicle to travel at a predetermined preset speed and following travel control to cause the own vehicle to travel so as to follow a preceding vehicle traveling ahead of the own vehicle, and
the vehicle control apparatus comprises
an acceleration control unit that accelerates the own vehicle by the constant-speed travel control or the following travel control in accompaniment with the deceleration control being ended.

14. The vehicle control apparatus according to claim 12, wherein:
the vehicle control apparatus is capable of performing at least either of constant-speed travel control to cause the own vehicle to travel at a predetermined preset speed and following travel control to cause the own vehicle to travel so as to follow a preceding vehicle traveling ahead of the own vehicle, and
the vehicle control apparatus comprises
an acceleration control unit that accelerates the own vehicle by the constant-speed travel control or the following travel control in accompaniment with the deceleration control being ended.

15. A non-transitory computer-readable storage medium storing therein a program applied to a vehicle control apparatus capable of controlling a travel speed of an own vehicle, the program causing a processor to perform processes comprising:
a turn signal determination process for determining that another vehicle is traveling in an adjacent lane adjacent to an own vehicle lane in which the own vehicle travels and the other vehicle has turned on a turn signal on a side of the own vehicle lane;
a speed determination process for determining whether another vehicle speed that is a travel speed of the other vehicle is lower than an own vehicle speed that is the travel speed of the own vehicle; and
a deceleration control process for performing deceleration control of the own vehicle with a speed obtained by a predetermined offset speed being added to the other vehicle speed as a target speed, in response to the turn signal in the other vehicle being determined to be turned on in the turn signal determination process and the other vehicle speed being determined to be lower than the own vehicle speed in the speed determination process.

16. A vehicle control method for controlling a travel speed of an own vehicle, the vehicle control method comprising:
determining that another vehicle is traveling in an adjacent lane adjacent to an own vehicle lane in which the own vehicle travels and the other vehicle has turned on a turn signal on a side of the own vehicle lane;
determining that another vehicle speed that is a travel speed of the other vehicle is lower than an own vehicle speed that is the travel speed of the own vehicle; and
performing deceleration control of the own vehicle with a speed obtained by adding a predetermined offset speed to the other vehicle speed as a target speed, in response to the turn signal in the other vehicle being determined to be turned on and the other vehicle speed being determined to be lower than the own vehicle speed.
